(19) United States
(12) Patent Application Publication
(10) Pub. No.: US 2016/0355424 A1
(43) Pub. Date: Dec. 8, 2016

(54) ASSEMBLIES AND METHODS FOR TREATING WASTEWATER

(71) Applicant: Colin A. LENNOX, Altoona, PA (US)

(72) Inventor: Colin A. LENNOX, Altoona, PA (US)

(21) Appl. No.: 14/545,270

(22) Filed: Apr. 15, 2015

Related U.S. Application Data
(63) Continuation-in-part of application No. 14/050,432, filed on Oct. 10, 2013.
(60) Provisional application No. 61/889,523, filed on Oct. 10, 2013.

(51) Int. Cl. C02F 3/06; C02F 3/10

(52) U.S. Cl. CPC C02F 3/06; C02F 3/101; C02F 3/109; C02F 2101/10

(57) ABSTRACT

An assembly for treating wastewater may include a vessel having an inlet configured to direct wastewater into the vessel and an outlet configured to direct treated water out of the vessel. The inlet and the outlet are generally disposed at opposite ends of the longitudinal dimension of the vessel such that the wastewater generally flows in the longitudinal direction. The assembly includes at least one mass of loose fibre matrix removably inserted into the vessel. The at least one mass of loose fibre matrix extends substantially across a width dimension of the vessel, wherein the width dimension is generally perpendicular to the longitudinal dimension. The mass of loose fibre matrix supports the growth of a biofilm-coated matrix that permits the flow of wastewater through the mass of loose fibre matrix. The vessel and the mass of loose fibre matrix are sized and arranged such that the wastewater is exposed to the biofilm-coated matrix for a time sufficient to remove a desired metal from the wastewater.

### TECHNICAL FIELD

The present disclosure relates generally to the field of water treatment, and more specifically, to assemblies and methods for treating wastewater.

### BACKGROUND

Contaminated surface and subsurface runoff water from storm events and Acid Mine Drainage is a major cause of water pollution in urban, residential and agricultural settings around the world. During and after rainstorms, storm runoff picks up a wide variety of contaminants as it flows across the surface and then into private and public waters. Runoff that flows across roads and parking lots picks up oil, grease and metals from automobile discharges; it picks up nitrate and phosphate from fertilized lawns and golf courses; it picks up organic waste, herbicides and pesticides from agricultural sites; and it picks up grit and colloidal particles from all of these locations. From water sources impacted by mining, which include surface and subsurface flows, water can acquire a wide variety of pollutants related to hydrologic fracturing for natural gas as well as acidified mine drainage water carrying heavy loads of dissolved metals. These contaminants pollute streams, rivers and lakes, aquifers, and groundwater unless collected (if possible) and treated prior to entering the receiving waters. In order to control negative water impacts, public and private organizations must adopt methods for intercepting and treating these contaminated waters.

Storm-water can be treated by a variety of methods, including retention ponds, constructed wetlands, infiltration basins, constructed filters, and open-channel swales that vary residence time, surface area, oxygen availability, and other biogeophysical chemical conditions. Treatment typically requires a combination of mechanical filtration (or settling) in combination with biological and chemical treatment. In general, mechanical filtration/settling remove the suspended particles, while biological treatment removes the nutrients and organic materials. The removal of nutrients, dissolved metals, and other contaminants by bacterial processes is commonly called Bioremediation and encompasses a host of biotic and a-biotic mechanisms including, but not limited to, filtration, sequestration, and bioaccumulation.

Extensive research, experimentation and monitoring have been done in the U.S. in the past three decades to evaluate and improve the methods of passive water treatment. Constructed wetlands, like natural “wetlands have a higher rate of biological activity than most ecosystems, they can transform many common [and uncommon] pollutants that occur in conventional wastewaters into harmless by-products or essential nutrients that can be used for additional biological productivity.” Treatment Wetlands, 2^{nd} Ed. Kadlec and Wallace. Pg 4.

One technique (called best management practices or BMP's) that has shown excellent efficacy in treating storm-water is the “treatment swale.” According to the Centre for Watershed Protection, the term “swale” refers to a “vegetated, open channel management practice designed specifically to treat and attenuate storm(water) runoff for a specified water quality volume.” A constructed wetland or treatment pond remains wet continuously and usually has water flowing through it to some depth. Subsurface constructed wetlands do not have open water and are generally made of gravel or cobble, allowing water to pass through without coming in direct contact with the atmosphere above. Due to the increased biological activity of wetlands per meter cubed, and the naturally analogous nature of pollutants to a remediating microbial species, nearly all pollutants can be removed from an impacted water source. A natural wetland requires time and conditions that exist by chance. A constructed wetland removes all limiting conditions, providing the environment required to host the microbes that remediate the pollutant.

Considering excess nutrients and organic and inorganic sediments, particles are mechanically filtered, while nutrients are bioaccumulated by naturally occurring heterogeneous bacterial colonies (biofilm) attached and growing on the surfaces of vegetation and soil particles. The biofilm incorporates excess nutrients and decomposed organics (such as manure and plant detritus ions) during its normal metabolic activity. More nutrients imply more bacterial growth and secondary productivity. All bacteria require phosphate, Potassium, and other micronutrients to survive and reproduce. The process of nutrient uptake by Chemo-heterotrophs is the primary mechanism of passive bioremediation in marine and freshwater environments.

These heterogeneous colonies of bacteria secrete sticky films that support the bacterial colonies. Biofilms, which can be found on virtually any surface on the planet exposed for more than a few minutes to an aqueous environment, provide structure and enormous protection for the various microbes therein to grow, metabolize, and reproduce. The microbes reproduce, continue to excrete EPS (extra polysacharidal matrix) in the form of a colloid (like mayonnaise), and the colony grows and changes through the process of succession to better fit its environment while simultaneously adapting the environment to better support the growing colony.

Surface associated biofilms are responsible for the majority of bioremediation within a natural wetland. Constructed wetlands provide even more surface area for bacteria with more plants in open waters, or gravel in subsurface flow wetlands, increasing the wide range of potential pollutants which may be remediated. To increase surface area is to increase the overall availability of bacterial biofilm that can cycle and metabolize pollutants, thus reducing the size and increasing the effectiveness and capabilities of the treatment vessel.

This growing biofilm possesses a chemical communication system called quorum sensing by which cells can, in effect, estimate their own population density. The cells produce small soluble molecules (homoserine lactones or oligopeptides) that diffuse out of the cell and into the external environment. At low population density these signal molecules have no effect on neighboring cells. As population density and signal molecule concentrations increases, as threshold is reached in which these molecules initiate regulation of genes in other bacteria in the neighborhood. In some cases genes are turned on and in other cases they are turned down or off. This altered gene function can have profound physiological effects on the cell population. Among these effect are altered response to antimicrobial compounds and especially, in the case of bioreactors, a certain reduction in cell division which results in keeping water channels open so that clogging does not readily occur.

There are numerous examples in the prior art of “treatment in a box” types of remediation systems, wherein polluted water is passed through porous and permeable treatment media that are encapsulated within various types of containers. Examples of these types of systems are disclosed in Vandervelde et al. (U.S. Pat. No. 5,281,332), Towndrow (U.S. Pat. No. 6,858,142), and Kent (U.S. Patent Application Pub. No. 2008/0251448). In these and other similar examples of prior art, the containment systems are comprised of rigid exterior walls and are not designed to be fitted into channels. There is one example in the prior art (Rainer, U.S. Pat. No. 5,595,652) of a treatment structure that is designed to snugly fit into a pipe, thereby preventing by-pass of water around the structure. This device is a simple tubular container filled with pieces of sponge that expand when exposed to water. Although this device may be suitable for use in enclosed pipes of circular cross section, it is not readily adaptable for use in open channels of non-circular cross section, particularly if the channel surface is irregular. For example, the expansion of this device would tend to cause the device to “pop out” of a trapezoidal channel as the device expanded because it comprises no means of attaching the device to the channel walls.

Although conventional open and covered water treatment wetlands are both useful for the treatment of contaminated storm water, each has drawbacks. For example, open water best management practices are poorly accepted in residential settings due to the nuisance surface flows that promote noxious pests such as mosquitoes and may produce drowning hazards for children, while subsurface flowing wetlands have the disadvantage of requiring relatively disruptive and expensive excavation when they eventually “plug up.” Biofilm only grows on the outside of gravel; larger gravel particles result in reduced surface area but slower rates of plugging. Consequently, both open and covered water treatment wetlands are generally much bigger than need be or required because the materials used as biofilm growing surface area is not optimal. The use of smaller gravel brings with it reduced flow and a greater likelihood of clogging, bringing its own host of issues. When plants represent the principle form of surface area available, the very thing that provides the surface dies and re-grows every year, and each plant is restricted to certain environments. Depending on the treatment order in acid mine drainage, plants can actually slow or stop the remediation of metals like manganese if left to decay in the treatment vessel. When a treatment system silts in over time from the accumulation dead organic material and/or settled metal precipitates, it must be cleaned out to restore flow. This must usually be done with heavy equipment, destroying the plants, and removing the majority of the surface area in the constructed treatment wetland, rendering it functionally useless in terms of remediation until the plants re-grow.

The present disclosure incorporates the advantages and eliminates the disadvantages of each of these prior art swale systems, while also incorporating several desirable new features that are not present in any type of conventional best management practice.

It is desirable to provide an assembly and method that is designed and constructed of environments on the macro and micro scale, to remediate acid mine drainage water using a microbial substrate that maximizes microbial colonies for the purpose of filtering and remediating compromised water and/or biosequestering metals and nutrients associated with agriculture, urban waste water, and acid mine drainage remediation processes.

### SUMMARY

According to various aspects of the disclosure, an assembly for treating wastewater may include a vessel having an inlet configured to direct wastewater into the vessel and an outlet configured to direct treated water out of the vessel. The inlet and the outlet are generally disposed at opposite ends of the longitudinal dimension of the vessel such that the wastewater generally flows in the longitudinal direction. The assembly includes at least one mass of loose fibre matrix removably inserted into the vessel. The at least one mass of loose fibre matrix extends substantially across a width dimension of the vessel, wherein the width dimension is generally perpendicular to the longitudinal dimension. The mass of loose fibre matrix comprises a biofilm-coated matrix that permits the flow of wastewater through the mass of loose fibre matrix. The vessel and the mass of loose fibre matrix are sized and arranged such that the wastewater is exposed to the biofilm-coated matrix for a time sufficient to remove a desired metal from the wastewater.

In some aspects of the disclosure, a method for treating wastewater may include the step of removably inserting at least one mass of loose fibre matrix into a vessel, wherein the at least one mass of loose fibre matrix extends substantially across a width dimension of the vessel and comprises a biofilm-coated matrix that permits the flow of wastewater through the mass of loose fibre matrix. The method further includes the steps of directing wastewater into the vessel, treating the wastewater, while in the vessel, by directing the wastewater in a longitudinal direction through the at least one mass of loose fibre matrix, and directing treated water out of the vessel. The longitudinal direction is generally perpendicular to the width dimension, and the vessel and the mass of loose fibre matrix are sized and arranged such that the wastewater is exposed to the biofilm-coated matrix for a time sufficient to remove a desired metal or pollutant from the wastewater.

### BRIEF DESCRIPTION OF THE DRAWINGS

In the drawings:

FIG. 1 is a diagrammatic illustration of an exemplary assembly for treating wastewater in accordance with aspects of the disclosure;

FIG. 2 is another diagrammatic illustration of the exemplary assembly of FIG. 1;

FIG. 3 is a diagrammatic illustration of an exemplary heat exchanger for use with assemblies according to the disclosure;

FIG. 4 is an illustration of the redox ladder; and

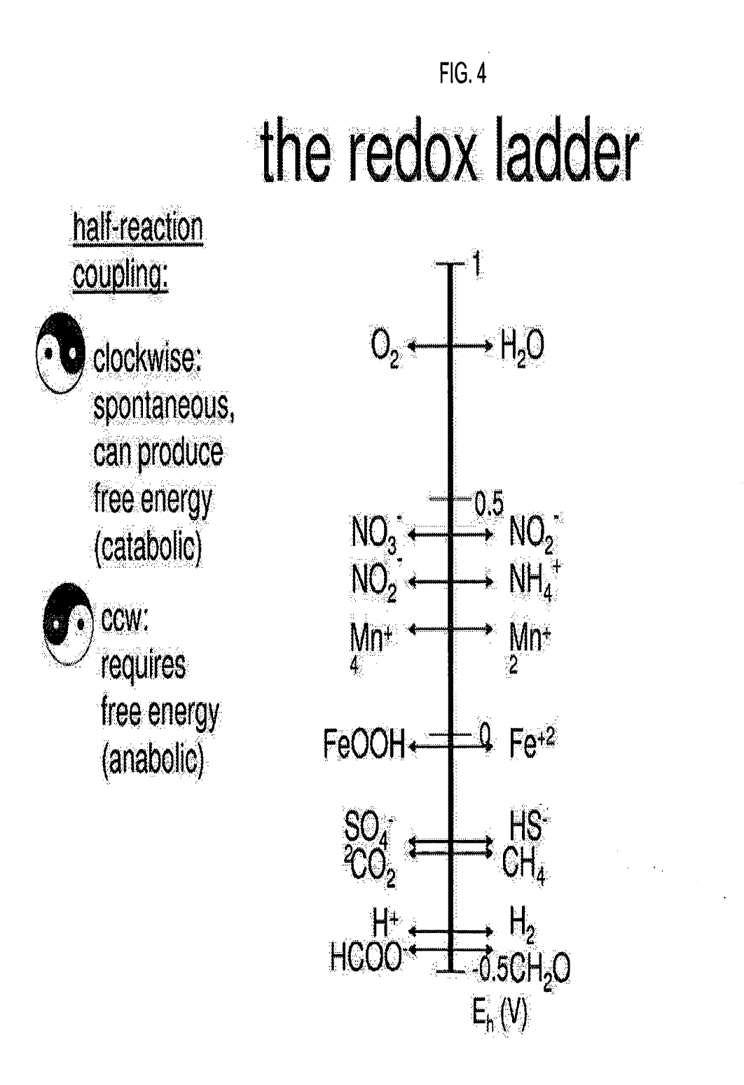

FIG. 5 is an illustration of an exemplary sequence of processes of the redox ladder.

### DETAILED DESCRIPTION

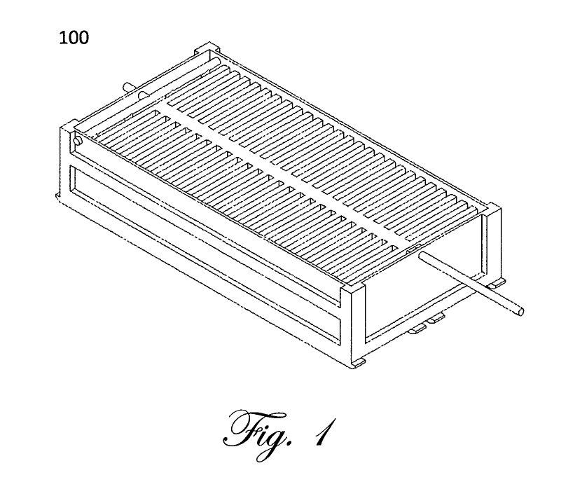

FIG. 1 is a diagrammatic illustration of an assembly 100 for treating wastewater. The assembly 100 may include a vessel 102 having an inlet 104 configured to direct wastewater into the volume 106 of the vessel 102 and an outlet 108 configured to direct treated water out of the vessel 102. The inlet 104 and the outlet 108 are generally disposed at opposite ends 112, 114 of the longitudinal dimension L of the vessel 102 such that the wastewater generally flows in the longitudinal direction generally shown by the arrow in FIG. 1.

The assembly 100 includes at least one mass of loose fibre matrix 120 removably inserted into the vessel 102. The mass of loose fibre matrix creates a surface area. The at least one mass of loose fibre matrix 120 extends substantially across a width dimension W of the vessel 102. The width dimension W is generally perpendicular to the longitudinal dimension L. The mass of loose fibre matrix 120 facilitates the presence of a biofilm coating. The mass of loose fibre matrix 120 is sufficiently porous that it permits the flow of wastewater through the mass of loose fibre matrix 120. The vessel 102 and the mass of loose fibre matrix 120 are sized and arranged such that the wastewater, as it flows through the vessel 102 from the inlet 104 to the outlet 108 is exposed to the biofilm-coated matrix for a time sufficient to remove a desired metal from the wastewater.

It should be appreciated that the vessel 102 has a length/volume chosen to utilize the Redox ladder, discussed in more detail below, for treatment of the wastewater. In some aspects, a single vessel 102 may be used. In other aspects, a system may comprise a plurality of vessels 102 in sequence. In either case, the purpose is to utilize microbial biofilm naturally grown and attached to an appropriate synthetic, inert substrate arranged, sequenced, or positioned to specify and maximize microbial biotic and abiotic conditions for the purpose of water decontamination or pollution remediation of wastewater. It should be understood that the wastewater may have been caused by negative consequences of mining, nutrients, storm water, and associated urban runoff directly and temporally and/or as post operational reclamation.

According to various aspects of the assembly, the masses of loose fibre matrix 120 may comprise organic or synthetic microbial masses. The mass of loose fibre matrix 120 may be positioned at an angle to flow ranging totally perpendicular to totally or nearly parallel. In some aspects, the assembly may include a plurality of inlets 104 and/or a plurality of outlets 108.

In operation, the assembly for treating wastewater may be used in a method for treating wastewater, that is, polluted water and its specific biochemical geospatial conditions. The method may include the step of removably inserting at least one mass of loose fibre matrix 120 into a vessel, wherein the at least one mass of loose fibre matrix 120 extends substantially across a width dimension of the vessel 102 and comprises a biofilm-coated matrix that permits the flow of wastewater through the mass of loose fibre matrix 120. The method further includes the steps of directing wastewater into the vessel, treating the wastewater, while in the vessel, by directing the wastewater in a longitudinal direction through the at least one mass of loose fibre matrix 120, and directing treated water out of the vessel 102. The longitudinal direction is generally perpendicular to the width dimension, and the vessel 102 and mass of loose fibre matrix 120 are sized and arranged such that the wastewater is exposed to the biofilm-coated matrix for a time sufficient to remove a desired metal from the wastewater. This process may be carried out with a single vessel or a series of vessels containing the substrate through which the water is channelized remediating pollutants in the process.

It should be appreciated that the actual process of determining the final form and additive manipulations to achieve increased system efficiency through project assessment and design criteria, the answers of which determine the vessels passive and active embodiment and effluents: “the design question matrix,” all must be answered and considered to come up with an effective, efficient, system.

For example, the physical site characteristics should be considered to determine how the assembly for treating wastewater should be configured in order to receive the polluted water and expel treated water under the force of gravity. The assembly may be a newly designed construction, or a retrofit to an existing water treatment system. In addition, the pollutant loading purity and overall volume of wastewater to be treated must be determined in order to design an efficient, effective, and durable system for wastewater treatment. The system designer should also consider how much storm surge will need to be retained before an overflow is triggered.

The system designer should also consider the potential active energy inputs and their efficiency thresholds compared to system effectiveness and complexity. For example, is it worth running electricity to a site in order to provide aeration or circulation pumping? Similarly, the system designer should consider what potential passive energy inputs are available, such as gravity/water head pressure, sun, artesian water pressure, geothermal heating cooling, or O2 adding trompes.

According to aspects of the disclosure, it is desirable to maximize the surface area of the mass of loose fibre matrix 120 relative to the volume of the vessel 102 and the flow rate through the vessel 102. For example, in slower flowing environments (5-50 gpm), a matrix with a tighter weave may be more useful, whereas higher rates of flow may require matrix with larger pore space to allow for increased flow without backing up portions of the system or causing short circuiting by forcing the water over the top of the mass of loose fibre matrix 120.

According to local requirements, the designer may desire to harvest mineral deposits or other materials by way of the assembly when such harvesting provides realistic rates of return. This decision of course depends on the potential harvestable materials. It may also be based on the available capital and/or in-kind investments.

It should be appreciated that the design of assemblies according to this disclosure will be based on various quantifiable and qualifiable and sustainable factors. For example, in an urban environment, the use of anaerobic bioreactors for the purpose of sulphur volitization and removal would not be well received by the neighbours, but on abandoned mines lands, hydrogen sulphide in the air is not a concern. Similarly, a system near populations can be designed with aesthetic and beneficial co-uses in mind. The cleaned effluent waters can be used for urban agriculture, then released to the natural environment or processed further for potable water through existing, reliable methods, coming full cycle.

Also, the evaluation of the assembly may take into consideration the long term maintenance and labour costs (50+ years), with cognizance of financial return and operation, and maintenance cost required on a seasonal to yearly basis. Acid mine drainage seeps and sources can flow for decades to centuries, requiring a permanent operation and maintenance schedule that must be fulfilled.

The physical site characteristics may include head, topography, soils, retention, vegetation, annual rainfall, heavy rain events and flooding history, erosion and sedimentation plans, latitude for purposes of solar input/shading, and expected high and low temperatures. The pollutant load, both biotic and abiotic, should be determined, as well as condition of the water, loading concentrations, space, volume, biologic geologic, hydrologic, atmospheric, concentration variation from dilution, and the like (see further claims for a more detailed list of design parameters).

In some aspects, procedural manipulations may be used to force pollutant remediation. Some procedural manipulations may include the addition of chemicals to alter pH, a carbon source to meet biological requisites of chemo-heterotrophic microbes, and on-site renewable energy sources to speed treatment times or reduce energetic barriers. This may also include mechanical monitoring units that regulate the addition of chemical or nutrient to reduce waste and adjust to daily weather, water, and loading

Theoretically, the disclosed assemblies and methods can treat contaminated water for anything that a natural or constructed wetland can treat. It should be appreciated that volumized matrix based synthetic wetlands sequester, filter, or remediate, any or all of pollutant forms including but not limited to total suspended solids, Fe, Mn, Cu, Zn, Al, Ammonia, Nitrite, Nitrate, Phosphate, pH buffering. These pollutants are can be predictably removed with the claimed invention depending on their loading, flow, volume, and redox potential so that certain metals or contaminants will remediated and/or collected in predictable succession.

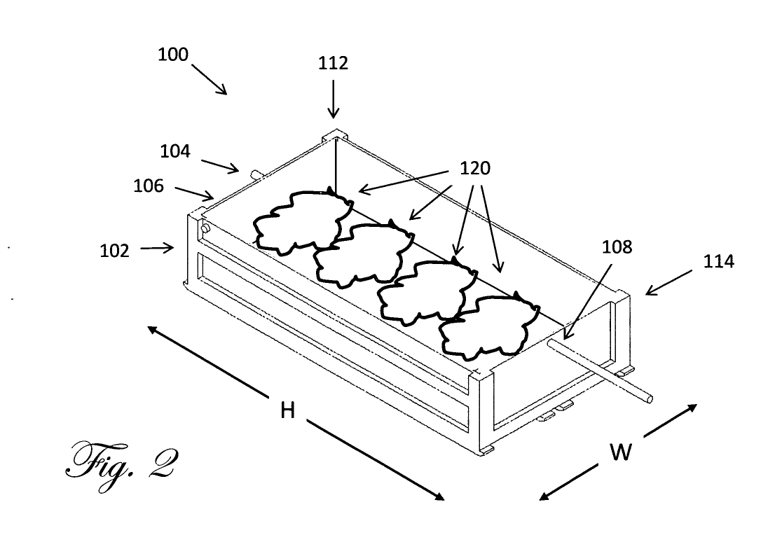

Referring to FIGS. 1 and 2, an open top or closed vessel or vessels in a natural or constructed environment which channels contaminated water that contains synthesized inert or reactive, or biologically-based inert or reactive masses of loose fibre matrix 120, which function as microbial substrate surface area. The masses of loose fibre matrix 120 may be placed at an angle or perpendicular to water flow. The presence of the biofilm on the masses of loose fibre matrix 120 provides pollution remediation through the active and passive properties of the microbial biofilm 120. This is functionally analogous to biofilms' roles and functions in a natural or constructed wetland.

The assembly 100 can remediate water impacted by mining, agriculture, or urban storm water or sewerage contaminants. The assembly 100 sequesters the pollutants in the vessel for cleaning and/or reclamation of the materials in the case of usable saleable metals, sludges, or muds. The assembly 100 can have qualities of lentic (pond/lake) and/or lotic (river/stream) flow characteristics dependent on the residency time and vessel form and volume. However, due to the high biofilm biomass, lower residency times are required to do the same remediation as systems with the same functions that do not contain microbial substrate masses of loose fibre matrix 120.

While an established biofilm is tenacious and requires a minimum flow to functionally thrive for purposes of “work”, flow must also be slow enough to maintain the volume of the free-floating biofilm which fills in the larger voids (or normal irregular hollows which are a consequence of using a loose fibre matrix that is partially compressed). Otherwise, the biofilm may slough off, reducing biomass if the flow is too fast. The masses of loose fibre matrix 120 promote slowed flow and increased retention as water is strained through them and the biofilm interacts with the water and contaminants, just like a constructed or natural wetland. A material loaded or saturated mass of loose fibre will further slow flow but has not been observed to stop or fully “plug up”. When a unit is full of material, biofilm, through quorum sensing, will maintain flow throughout the vessel by slowing the growth of cells and EPS. This maintains open channels in the biofilm and collected material that reduces biofilm stress by providing fresh food and energy, dissolved O₂. Laboratory chemical analyses from influent and effluent show load concentrations leaving a “saturated” vessel to be the same or slightly higher than the influent while maintaining the same water level and flow rate.

It should be appreciated that existing remediation assemblies can be retrofit with assemblies 100 disclosed herein. Due to the variety of forms and physical embodiments that are used for remediation, a broad range of applications exist through the addition of synthetic, inert, or biologically reactive microbial substrates. The physical environment of the substrate is optimized for the growth of specific microbial masses. These microbial masses, along with the physical structure of the inert substrate, filter, bioremediate, and biosequester specific pollutants. This remediation is dependent on the specific environment being treated and the vessel construction developed for the planned or existing environmental niche.

The biofilm that grows and fills the mass of loose fibre matrix 120 and the volume between the mass of loose fibre matrix 120 is naturally selected by the environment and thus has no need for inoculation by lab grown or engineered microbes. “If you build it, they will come,” is an appropriate metaphor from the movie Field of Dreams. Of course, a vessel can be inoculated by placing a “seed” mass from an established system into the new system's influent. The introduced mature biofilms will help to establish the new system and reduce start up time. Similarly, a system that is established, and then thoroughly cleaned, will “bounce back” to full effectiveness faster than a brand new system as only part of the existing biofilm is ever removed. It is possible that certain well-established certain systems may develop more effective microbial communities due to a synthetic niche's maximized treatment potential. For example, a “seed” system may be chosen for its content of certain manganese-oxidizing bacteria that have adapted to take maximal advantage of it manganese-oxidizing ability. A stable environment promotes specialization and populations exhibiting mature succession. This artificially promoted succession changes the diversity of the biofilm to one more effective in oxidizing manganese. This technique of synthetic succession could produce a biofilm that has not only high efficiency but also the resistance and heartiness of a naturally occurring biofilm. In order to be effective after “seeding” the new environment must be quite similar to the old one, otherwise the biofilm adapt still further. With time, a new, mature biofilm will develop, but it might not have all of the desired characteristics of the previous one.

Synthetic niches can be designed and placed in sequence to favor certain microbes that remediate different pollutants dependent on their redox potential or degradative recalcitrance. Thus, the mass of loose fibre matrix 120 may support the growth of many species or just one. For example, a heterogeneous biofilm mass can remediate a variety of pollutants, but only sulfate reducing bacteria species will reduce sulfur.

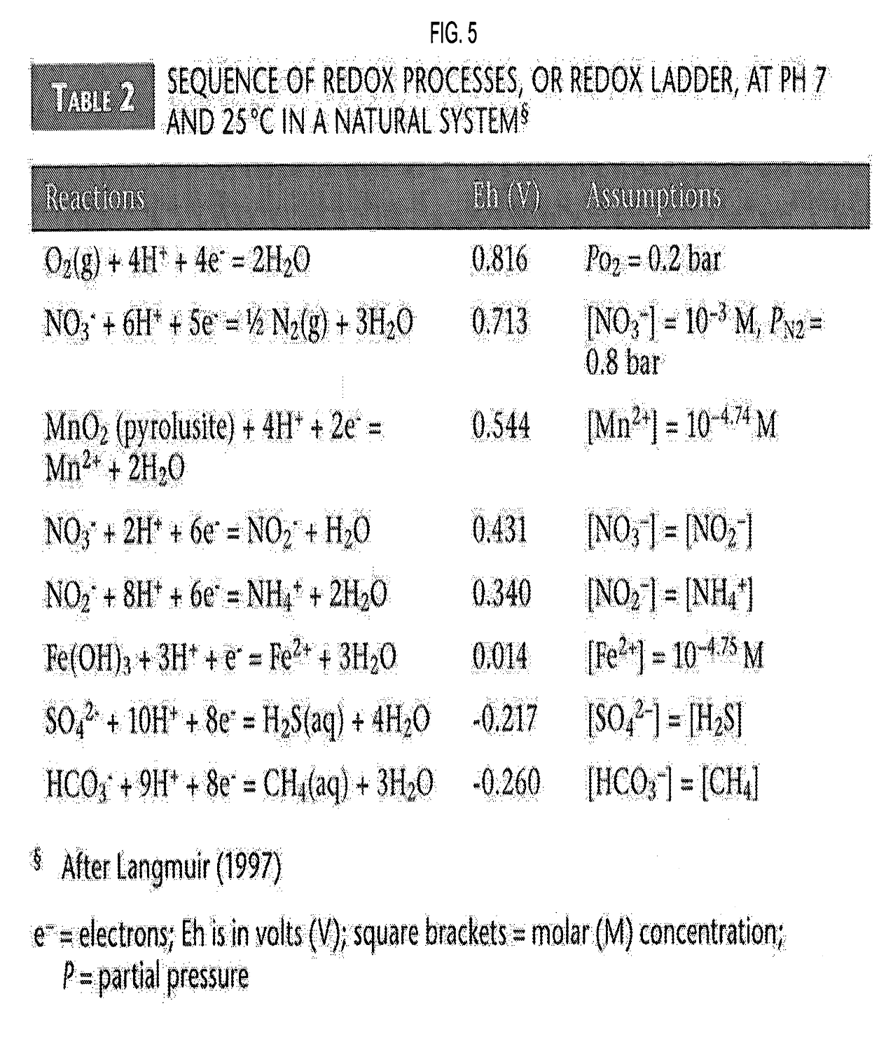

The assembly 100 may be configured to provide the requisite synthetic niches required to remediate different pollutants dependent on their redox potential based on the redox ladder of pollutant remediation, as illustrated in FIGS. 5 and 6. In some aspects, one vessel or a series of vessels (i.e., niches) may be provided to remediate pollutants in order of their redox potential, from highest potential to lowest potential. For example, for contaminated mine water, the remediation order in AMD impacted water with net alkaline water may start with organic nutrients, then iron, then manganese, then sulphur. It may be that each nutrient/pollutant must be essentially removed before the next pollutant is affected. For example, in the 2012-13 Glasgow, Flight 93, and Gaber Brown Wetland BioReactor study, manganese will not oxidize unless all of the dissolved iron in the water is below approximately 0.4-0.35 mg/L. Generally, after Fe concentrations have dropped below this amount, the Mn is then available for oxidation and drops out quickly from solution in an oxidized form. Aluminum, at observed concentrations in the study, did not appear to block Mn oxidation.

Thus, it should be appreciated that if a vessel 102 with a mass of loose fibre matrix 120 is long enough and has the necessary volume to residence time ratio, all pollutants will come out in redox order. For example, a distal end of the vessel 102 would have to be anoxic (i.e., no O₂) for sulphur reducing bacteria to grow so that sulphur is removed.

In essence, the vessel 102 may comprise a trench, a pipe, or any long linear embodiment acting as lotic flow environment (i.e., stream/river flow) where the width is significantly less than the length. Such a vessel configuration produces a greater and more distinctive separation of pollutants as they are pulled from the contaminated water (from influent to eventual effluent) by the masses of loose fibre matrix 120. The vessel should be easy to clean by hand or machine and more accessible (e.g., 4-6 ft wide).

The economic return of harvesting saleable by-product from the vessels is the ultimate purpose of this invention and its subsequent claims. The large scale of recycling and related materials has not been economically feasible mostly due to the high labor costs related to the materials and the large machinery investment required. In the present application, all efforts have been made to reduce the costs of treatment of the embodiment and in particular the procedural claims for cleaning and maintaining the systems. A large initial cost in labor is required to volumize the substrate to a useable surface to volume ratio (Surface Area/Volume). For example, one bale of coconut coir will take one person approximately hours of hand shredding to fill one treatment cell of a system. A bale of coir simply can't be placed into the system with any expectation of an appropriate s/v ratio.

In order to facilitate this process the following device is required.
1. A machine that first shreds and then delivers at speed/pressure the coir through a long flexible tube of several inches in diameter which functions similarly to an insulation blowing machine. Design emphasis on use of coir bales fed into the shredder.
2. At heart, the machine is a chipper/shredder modified with a hose at its outlet that blows the now shredded coir into the treatment cell.
3. A blower is attached to aid in delivering the loose material through the delivery hose (like blown insulation).
4. This machine reduces to minutes what takes hours of tedious labor (the inventor is speaking from personal experience). In a system requiring hundreds of bales of coconut coir, this one person machine, mounted on a pallet or service flatbed, would reduce labor costs many fold.
5. If a larger engine/shredder is used, material like old carpet could be shredded and used, though coir provides much lighter weight surface area/volume and is much easier to clean. For purposes of recycling post consumer goods, a variety of loose fibre materials should be considered. Coir is used because of cost, availability, durability, and previous success in use as substrate.

Cleaning can be accomplished through, a system of large flush pipes incorporated into the treatment cells wherein back flushing or rapid outflow can be achieved. If a pump is attached to the vertical standpipe on the outflow, the material in the cell can be stirred, vibrated, or aggressively “bubbled” to knock material loose from the substrate. In this procedure the outflow valve is opened and the vessel is quickly pumped out, leaving the substrate partially cleaned and the bottom of the cell free from accumulated material.

All pipes and manifolds in these systems must be built on the inside of the cells so that they can easily be accessed, cleaned, repaired, and replaced. Outside pipes could be moved or cracked from settling fill after the units have been buried.

For access to units that are anaerobic, the lids used to cover and seal the vessels must be removable in order to access the substrate, materials, and any internal plumbing.

With regards to cleaning coir or loose fibre, a mounted cleaning unit comprising:
1. a conveyor belt to carry loaded coir through the machine and the cleaning process,
2. a series of variable pressure washers nozzles,
3. the conveyor belt which passes through one or more variable pressure sprayers using higher flow by lower pressure to remove material that the higher pressure nozzle from the washer heads have loosened,
4. a series of sluice boxes to separate materials according to weight, mass, or volume (floc, gravel, sand, sludges),
5. after the substrate material has been cleaned, it is returned to the box if it is still durable enough to go another cycle of treatment and cleaning and still act as a useful substrate. (coconut coir for example can last through several cleanings),
6. this same machine should also be able to process plastic bonded panels of matrix with the same pressure washer heads, dipping baths, and sluices (see paragraph 001 for related primary application),
7. return pumps are to be used to recycle the water as much as is feasible,
8. as the material is separated from the substrate, multiple effluents can deliver the separated material to hoses for flush ponds, de-watering socks, or holding tanks on trucks,
9. this machine, like the coir/loose fibre shredder and blower, should be truck mounted and as small and durable as possible. In practice they must be transported to sites often far from good roads and be required to function for days or weeks far from maintenance shops.

In some configurations, the assembly 100 may include multiple vessels 110, each with its own influent and effluent. It should be appreciated that a first vessel 102 is put into use, and the second and subsequent vessels are brought on line only as flow volume increases. The flow through each vessel may cascade over weirs or through pipe manifolds to the next vessel when overflow occurs. This arrangement allows the treatment to be confined to as few masses of loose fibre matrix 120 and/or vessels 110 as possible. This reduces maintenance, cleaning, and replacement of matrix if/when their lifespan is reached, and maintains a minimum flow for purposes of treatment. Too many units dividing flow during times of very low flow would disturb material reclamation as it would spread a small amount of material over a large surface area, making cleaning and reclamation more expensive. By centralizing the flow, the load/material is also sequestered in the fewest number of units. Switch-backs on a steep or contoured site compress linear (for example, one long trench) treatment system into very small spaces. It should be noted that where available space is limited, a number of vessels can be stacked vertically. One or more of the plurality of vessels can be buried or built as a tower (to be insulated or sealed if needed).

In still other circumstances, the assembly 100 may include wide embodiments where the width of the vessel is greater than the length. In such embodiments, flow across and through the vessel may be normalized to reduce slow/inefficient zones by use of a manifold of pipe influents and effluents.

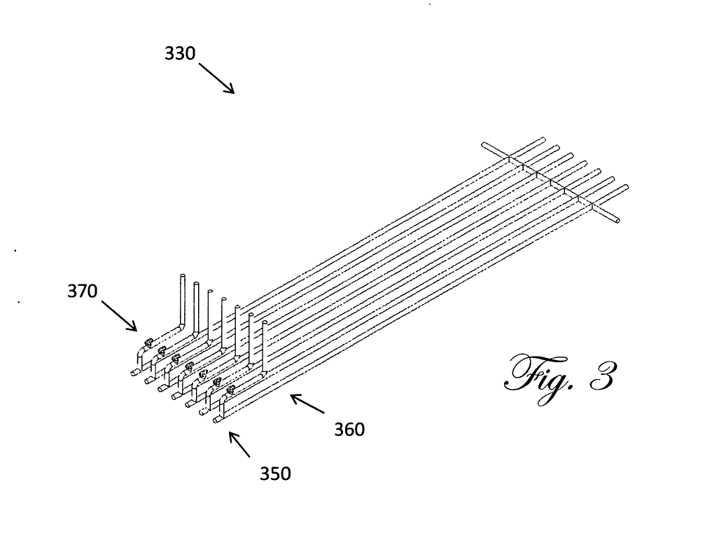

Referring now to FIG. 3, in a trench embodiment, a heat exchange assembly 330 may include effluent pipes 350 can be buried in the ground or concrete 360 below the trench/vessel 102 to act as in-floor radiant heating exchanges. The heated effluent water's heat energy is conducted to the bottom and/or sides of the treatment cell. The warmer effluent exchanges its heat energy with the cooler influent as it passes underneath the vessel, thereby warming the influent water and microbial community while also cooling the effluent and, thus, reducing concerns over thermal pollution.

In the situation where pvc pipes of the heat exchanger are laid and buried in place as one long trench (e.g., 20+ ft. long), a straight and easily accessible clean out/flush out plug should be added along with a shut off valve 370 to control each individual outflow pipe. A long ramrod clean out scrubber can then be used to clean and clear out any obstruction, which may develop over time.

The manifold will normalize the effluent cross section, and by adding shut off ball valves 370, each pipe can be selectively changed and/or shut off for cleanout. Also, pipe flow can be individually adjusted, thereby evening out the flow through the vessel across the profile. For example, ball valves may be slightly closed on effluent manifold pipes that are connected to the middle of the trench while the outside manifold valves are open full to allow for more flow. Water in a flowing environment moves fastest in the middle and top of the channel where the least amount of drag/inertia from the sides and bottom of the stream bed/vessel is exerted. An adjustable manifold normalizes this flow pattern to get better treatment rates.

It should be appreciated that larger pipes may be set into the sides above the designed treatment draft water line so that during flood events the system does not overflow the banks of the vessel(s). For example, 2″ pipes may be used as effluent, while 3-5″ pipes may be used as overflow.

In some aspects, the assembly 100 may include stepped treatment cells that follow the contours of the land, reducing site footprint and harnessing gravity/head pressure to greater effect.

In an exemplary assembly 100 that is in a natural or urban environment that is capable of supporting delicate or sensitive species such as trout or Class A macro-invertebrates due to increased water quality to tolerable levels, it may be beneficial to incorporate fish ladders and other methods of ingress/egress for natural wildlife. Trout ladders can be added such that holes and passages are built into the masses of loose fibre matrix so that aquatic life can pass through. To reduce the increased flow and short circuiting this presents, it would be useful to place the passages in an arrangement such that they are as far away from each other as possible, creating an extreme back and forth pattern (e.g., all the way from one side of the trench or embodiment to the other).

In some aspects, a vessel or series of vessels 102 may be arranged with a singular or a plurality of influents and effluents so as to create a synthetic niche conducive to pollutant remediation based on available or introduced microbes. Circulation in a vessel or among different vessels at different points of treatment may aid in different portions of the treatment process where one vessel may produce a by-product or material that aids in treatment of another pollutant in a previous or following embodiment. For example, activated sludge waste treatment systems may introduce microbes from one step of the treatment train to another. Some exemplary vessels 102 may include influents and effluents that can be used for water and contaminant re-circulation through a singular vessel substrate or a plurality of vessel substrates. For example, the recirculation of water carrying loads of Ferric Iron (Fe(3)) returned to a step containing large amounts of Ferrous Iron Fe(2) for purpose of hydrolyzing the Ferrous to Ferric in an anaerobic (reducing) environment.

In some aspects, a vessel 102 may include multiple inlets and outlets with flows either vertical or horizontal for the purpose of increasing residence time/and or surface area contact within the vessel using synthetic inert microbial substrate for the purpose of flow diversion. A vertical or covered and sealed horizontal flow embodiment can also be used to remove O₂ without the need for additional nutrients while eliminating O₂ diffusion. A vertical flow embodiment can also be used to add O₂ by forcing the water down through the matrix, then back up to the surface for the diffusion of more O₂ that would be consumed by biotic and abiotic reactions as the water passes through the matrix.

A Manifold made of pipes of influents and effluents with many holes can be used to normalize flow within a vessel 102 to maximize matrix surface contact to water (making many influents and effluents out of one point source in order to spread flow across a whole section of an embodiment). Such an arrangement may reduce “dead-zones” of treatment as water moves through the masses, thereby more effectively utilizing the available surface area/biofilm.

The assembly 100 may include a mobile or transportable modular design to be placed on site or moved for emergency response. Mobile emergency embodiments can be pre-inoculated and ready for treatment in the case of oil, fracking water, or other chemical spills or contamination where time and immediate treatment is necessary to preserve public or ecological health. Mobile emergency embodiments can be made energetically active by providing an electricity source to units that circulate, add heat, add oxygen, nutrients, pH amendments, and the like. Such a mobile and transportable unit must be size and arranged light enough and/or small enough to move to a site from a flatbed truck, while at the same time being strong enough to support its own weight when filled with fluid and operating.

In other aspects, treatment trains may also contain flushing and de-watering ponds/tanks or socks for sludge/mud capture during cleaning where:
a sludge pond or containment is cleaned or drained from previous clean out, settled sludges and precipitate will fill the bottom and the water is drained from the top down slowly;
flow is shut off to the trenches or vessel(s), and the masses of loose fibre matrix are cleaned in the remaining water within the vessel(s) and the substrate is temporarily removed
   or masses are removed and then cleaned in the claimed washing and separation machinery [see above],
water in the vessel(s) or trenches are drained to the empty sludge pond if not using claimed machinery from above for purposes of material harvesting,
masses of loose fibre matrix are replaced and flow and treatment resumes;
sludge pond material is allowed to settle entirely, and the water is drained from the top down to the level of sludge; and
sludge is removed and the pond is emptied for next clean out if necessary.

It should be appreciated that the masses of loose fibre matrix 120 can be cleaned by shaking them vigorously within the vessel 102 during flow or after flow has been turned off. The masses may also be removed, cleaned, and replaced for reuse by simple and very accessible means.

In some aspects, the masses of loose fibre matrix 120 can be vibrated and shaken vigorously by a machine that loosens and deposits the accumulated materials back into the vessel 102 for sludge accumulation and removal. For example, a machine with vibrating or sonicating arms may be positioned to contact and shake the masses while they are still in place in the vessel 102.

High pressure air bubblers connected to large capacity air compressors of at least 100 gallon volume can also be attached to poles and inserted to the bottom of the vessel. The released air will cause bubbles to permeate and disturb the mass, lifting the loose fibres to the surface and knocking heavier material free to settle to the bottom. If the loose fibre is left in the vessel and a flushing method is chosen to remove the material now accumulated at the bottom of the vessel, a vibrating or sonicating (like the high-end electric toothbrushes) rod can be inserted into the vessel, causing the bubbles trapped in the loose fibre mass (which is now a floating island on the top of the vessel) to break free and travel to the top, allowing the mass to settle while breaking free more material. This process of bubbling and sonicating can be repeated until the fibre is free of material. The vessel is then flushed or pumped out rapidly.

The mass settles to the bottom, the vessel is refilled and sonicated and more loose fibre is added to the top if needed using the fibre shredder/blower embodiment as claimed above.
1. It should be noted that certain frequencies will affect the mass in different ways and to different levels of effectiveness depending on the purpose (shaking loose bubbles will require a different frequency of vibration than is needed for breaking accreted or dense materials from the fibres of the substrate. Thus it is required that the vibrating or sonicating mechanism be able to work over a range of frequencies and amplitudes.
2. It should also be noted that in order to preserve the living ecosystem of the vessel that care should be taken in selecting amplitudes that could injure or damage higher organism like macro-invertebrates or vertebrates. An Oxidized system capable of supporting higher order organisms should be cared for, especially when the organisms aid in the “wetland” cleaning process such as maintaining pore space, sequestering carbon, or providing aesthetic value through the biodiversity of the synthetic niche.

Thicker masses of loose fibre matrix 120 may be more difficult to clean, making effective cleaning of a mass a factor of its thickness when it is no longer suspended in solution. When suspended in solution the most efficient cleaning mechanisms differ from a mass sitting on a conveyor because the volume to surface area is different. Water logged loose fibres pulled out of a cell and laid on a conveyor belt to be run through pressure washers and dipping baths require more effort because the space between the fibres is much less (like pressure washing a dirty mop, a bucket of clean water that you suspend and shake the dirty mop in is more effective than taking a hose to it). This then means that a re-useable mass can only be as thick as the method that will be used to clean it. For example, if masses are only an inch thick and not clogged with metal precipitate, simple vigorous shaking is all that is needed. Masses of loose fibre matrix 120 can also be partially cleaned by increasing flow to the point that materials begin to break free and are flushed down stream to a holding or sludge pond for separation and dewatering. In addition, the physical flexing and bending of the masses to loosen accreted materials before pressure washing increases the effectiveness of the cleaning process. For example, a physical embodiment with rollers (like those used before clothes dryers to squeeze and wring out water) can be used to mechanically loosen materials hardened on the masses without damaging the masses themselves as they move through the conveyor system

In some aspects, non-permeable flanges or insets may be disposed along the length of the vessel 102 at bottom and/or sides thereof. Such flanges or insets may accept, space out, hold in place, and prevent “short circuiting” by going around/under panels which may otherwise reduce system treatment effectiveness and residence time.

It should be appreciated that in-situ active and passive energetic sources may be utilized to maximize the specific biotic and abiotic characteristic conditions within the vessel to maximize the biofilm remediation potential of pollutants. How an assembly is designed and integrated determines what it will remediate and where/when such remediation will occur in the treatment train. Optimization of the assembly 100 will determine how effective and efficient the assembly 100 will be at performing the task of remediation (e.g., getting the most out of the masses of loose fibre matrix 120 by manipulating the embodiment environment).

For example, some embodiments of the assembly 100 may be configured to add or remove oxygen, heat or cool the vessel and protect it from incident solar heating. Other configurations may offer protection from seasonal temperature variation (subsurface or insulated), pH adjustment through lime or caustic soda additions, addition of nutrients, carbon sources and regulation of flow, residence time, and/or volume. Some embodiments may include a mechanical system for 02 or 03 introduction, piping with bubblers, or venturis for treatment before or during remediation, to aid in microbial metabolism, and/or to encourage additional metals precipitation. Various embodiments may include in-situ microhydro, solar panels, aerators, pumps for re-circulation, geothermal, other forms of heating or electricity generation. Some embodiments add covers for insulation, subsurface insulation (e.g., deeply buried trench that is still open topped or a buried pipe with masses that can be removed, cleaned, and replaced), and/or thermopane glass for IR capture and greenhouse effect.

In some aspects, a thermopane covering may be used to increase temperature and insulation properties of the embodiment to warm the water passively for purposes of microbial metabolism and/or protect from freezing.
1. a clear covering may include holes for the passage of air for purposes of increasing the concentration of oxygen.
2. further, the covering may include tubes, painted black or made from a black material, that carry air to the water moving below,
   a. these tubes should extend perpendicularly from the clear covering and be about 1-2 feet tall and similarly drop down into the water.
   b. these tubes should be about ½″ in diameter or larger and have a covering over the top to stop precipitation from entering the tube and freezing.
   c. the flow of water passing the opening or openings in the tube in contact with the flowing water will reduce the pressure in the tube, carrying air bubbles into the embodiment if flow is fast enough, or at the least providing for surface area for O2 dissolution that will not freeze closed during cold weather.

In an embodiment designed for aerobic conditions that must be insulated or otherwise sealed from the outside environment, water warmed through the use of a clear “greenhouse/thermopane” covering that is air tight (no atmosphere bubbles in the cell) will encourage a sealed environment that promotes the growth of cyanobacteria for the purpose of O2 creation. This O2 creation will help to satisfy the oxygen requirement for metal oxidation oxidizing. When combined in series with a darkened sulfur reducing cell coming before the seal but transparent top allowing for photosynthesis, a closed system can supply first alkalinity in the sulfur reactor, then O2 to satisfy COD of the oxidizing dissolved metals.
1. a nutrient drip and soluble carbon source will still be required to provide for metabolism. A mix of mushroom compost and cheap carbohydrates in an Aerobic digester can be attached to a filter and a peristaltic pump. A flow meter is used to adjust the speed of the peristaltic pump to the appropriate volume of water. As the biofilm in the system is large compared to volume and is heterogeneous, a new system will require considerably more “food” to establish itself than a wild mature biofilm, but once there will feed off of the bioaccumulated and constantly cycling nutrients and carbon. This reduces carbon and nutrient requirements over time. When a system is cleaned, it will require more “food” to rebound to full size, but to a lesser extent than newly established biofilm in a new system.
2. it is expected that this biofilm treatment system, which can use a water tight seal and can biologically provide oxygen has particular use in the zero gravity (conditions of space flight). A system like this has the advantage of being sealed, insulated, passive, and capable of absorbing noxious gases. It is also capable of being used as a heat sink to cool or warm various components of a space faring vessel like the International Space Station. The key factors of this design lie in its being sealed, biologically dense, capable of operating over a range of parameters, and the fact that it is energetically passive in its operation.

In some aspects, the vessel or portions of the vessel may be painted black or a black pond liner may be used for additional thermal absorbance.

Embodiments can utilize ambient subsurface earth and water table temperatures (thermal mass in open and closed loop systems) averaged at 45-55 degrees Fahrenheit at least 1 meter underground. These embodiments may utilize the natural thermal mass to increase bacterial activity during climates and/or seasons that otherwise shut down microbial metabolism. For purposes of useful work dependent on the biofilm mixture and treatment cell purpose (e.g., anything less than about 40 degrees F.). Minimum operating temp for a geothermally linked system is then always above freezing.
1. it has been observed that a mature biofilm can remediate dissolved Mn in useful quantities at any temperature above freezing, so the above claim is based on the presence of a mature biofilm that has reached maturity before the seasonal cold arrives.

Constructing a subsurface system can also cool water that has been heated so that thermal pollution in the receiving water body is not a concern.

In accordance with aspects of the disclosure, use of the assembly 100 is based on the RedOx ladder sequencing that first heats, passively or actively, the influent or effluent of water for the purpose of maximizing biofilm metabolism and then uses geothermal cooling to lower water temperature to reduce thermal pollution upon re-release to a natural environment 02. The cooling may be achieved via either a radiant floor heat exchange unit or just by buried pipes cooling the effluent underground.

In accordance with the present disclosure, anything that a natural or constructed wetland can treat for may, theoretically, be remediated by the assemblies 100 of this disclosure. According to various aspects of the disclosure, and supported by experimentation, applicant has direct evidence and/or has observed through experimentation that volumized matrix-based synthetic wetlands sequester, filter, or remediate (biotically or abiotically) the following: total suspended solids, total dissolved solids, Fe, Mn, Cu, Zn, Al, Ammonia, Nitrite, Nitrate, Phosphate, and pH buffering through biological production of alkalinity through decomposition.

Assemblies according to this disclosure may be designed to maximize the efficiency of metals bioreactors, nutrient bioreactors, urban run-off bioreactors, combination bioreactors for multiple biofilms of multiple characteristics and niches with multiple purposes contained within the same vessel (redox). This allows for multiple steps of the redox ladder to be performed within the same vessel.

Matrix substrate materials to be used include, but are not limited to, materials that have the same basic function, that of a biofilm maximizing substrate for the above stated purposes in the above stated manner and manipulations. The loose matrix material may include, for example, inert plastic substrate with no associated ionic or electric charge, material with a negative charge, material with a positive charge, organic and/or biodegradable material, plant based or biodegradable plastic, coconut coir matrix, woodchips, of chopped or shredded post industrial material of an inert nature. In some aspects, the coconut coir may be used for plugging holes or short-circuiting or as a disposable matrix that biodegrades after a few seasons of use.

In various aspects, the coconut coir may be bonded together with waterproof adhesive to form a biodegradable mass that will last several years but may also break down when disposed of. This may reduce the overall volume of the waste piles/dumps or over time render a cleaner sludge for purposes of harvesting.

It should be appreciated that a loose fibre substrate may have the intentional characteristic of dissolution or biodegradation over a specific time frame. This intentional dissolving (like dissolvable stitches in the medical field) or biodegradation to the point that the matrix no longer supports the weight of the accumulated material is a method for saving space in an embodiments volume for accumulated material. This also gives the embodiment the ability to fill in all the available space and volume with accumulating material as the matrix dissolves, and while 95% open volume for matrix is the norm, the additional volume may be needed or useful.

It will be apparent to those skilled in the art that various modifications and variations can be made to the assemblies and methods for treating wastewater of the present disclosure without departing from the scope of the invention. Throughout the disclosure, use of the terms “a,” “an,” and “the” may include one or more of the elements to which they refer. Other embodiments of the invention will be apparent to those skilled in the art from consideration of the specification and practice of the invention disclosed herein. It is intended that the specification and examples be considered as exemplary only.

What is claimed is:

1. An assembly for treating wastewater, comprising:
a vessel having an inlet configured to direct wastewater into the vessel and an outlet configured to direct treated water out of the vessel, the inlet and the outlet being at opposite ends of the longitudinal dimension of the vessel such that the wastewater generally flows in the longitudinal direction; and
at least one mass of loose fibre matrix removably inserted into the vessel, the at least one mass of loose fibre matrix extending substantially across a width dimension of the vessel, the width dimension being generally perpendicular to the longitudinal dimension, the mass of loose fibre matrix supporting growth of a biofilm-coated matrix that permits flow of wastewater through the mass of loose fibre matrix,
wherein the vessel and the mass of loose fibre matrix are sized and arranged such that the wastewater is exposed to the biofilm-coated matrix for a time sufficient to remove a desired metal from the wastewater.

2. An assembly according to claim 1, wherein the vessel includes a man-made container or a constructed trench.

3. An method for treating wastewater, comprising:
removably inserting at least one mass of loose fibre matrix into a vessel, the at least one mass of loose fibre matrix extending substantially across a width dimension of the vessel, the mass of loose fibre matrix supporting growth of a biofilm-coated matrix that permits the flow of wastewater through the panel;
directing wastewater into the vessel;
treating the wastewater, while in the vessel, by directing the wastewater in a longitudinal direction through the at least one mass of loose fibre matrix, the longitudinal direction being generally perpendicular to the width dimension; and
directing treated water out of the vessel,
wherein the vessel and mass of loose fibre matrix are sized and arranged such that the wastewater is exposed to the biofilm-coated matrix for a time sufficient to remove a desired metal from the wastewater.
